(19) United States
(12) Patent Application Publication
(10) Pub. No.: US 2013/0327045 A1
(43) Pub. Date: Dec. 12, 2013

(54) GAS TURBINE COMBUSTION CHAMBER WITH FUEL NOZZLE, BURNER WITH SUCH A FUEL NOZZLE AND FUEL NOZZLE

(71) Applicants: Timothy A. Fox, Hamilton (CA); Uwe Gruschka, Kaarst (DE); Steven Williams, Charlotte, NC (US); Ulrich Wörz, Tega Cay, SC (US); Jaap Van Kampen, Roermond (NL)

(72) Inventors: Timothy A. Fox, Hamilton (CA); Uwe Gruschka, Kaarst (DE); Steven Williams, Charlotte, NC (US); Ulrich Wörz, Tega Cay, SC (US); Jaap Van Kampen, Roermond (NL)

(21) Appl. No.: 13/877,993

(22) PCT Filed: Oct. 4, 2011
(86) PCT No.: PCT/EP11/67243

§ 371 Date: Jun. 4, 2013

(30) Foreign Application Priority Data
Oct. 5, 2010 (EP) 10186501.2

(51) Int. Cl. F02C 7/22

(52) U.S. Cl. CPC F02C 7/22
USPC 60/734

(57) ABSTRACT

A gas turbine combustion chamber includes a fuel nozzle with a cylindrical nozzle tube, in which a fluid flows, and a convexly formed nozzle cover, which is arranged downstream of the nozzle tube. The nozzle cover has a central point and a plurality of through-openings through which the fluid leaves the nozzle tube. The through-openings are arranged at different radial distances from the central point at two circular lines.

### CROSS REFERENCE TO RELATED APPLICATIONS

This application is the US National Stage of International Application No. PCT/EP2011/067243 filed Oct. 4, 2011, and claims the benefit thereof. The International Application claims the benefits of European Patent Application No. 10186501.2 EP filed Oct. 5, 2010. All of the applications are incorporated by reference herein in their entirety.

### FIELD OF INVENTION

The invention relates to a gas turbine combustion chamber with at least one fuel nozzle. The invention also relates to a burner with such a fuel nozzle. The invention also relates to a fuel nozzle.

### BACKGROUND OF INVENTION

In the light of international efforts to reduce pollutant emissions from furnaces, particularly gas turbines, burners and methods of operation for burners have been developed in recent years which have particularly low nitrous oxide (NOx) emissions. In such cases, emphasis is frequently placed on the fact that in each case such burners are able to be operated not only with one fuel, but, where possible, with a wide variety of fuels, for example oil, natural gas and/or low-calorie fuels, also referred to hereinafter as synthesis gas, as required individually or in combination in order to increase security of supply and flexibility during operation.

Synthesis gas burners are characterized in that synthesis gas is used as a fuel therein. Compared with the conventional gas-turbine fuels, natural gas and crude oil, which substantially comprise hydrocarbon compounds, the combustible components of synthesis gas are substantially carbon monoxide and hydrogen. To allow a gas turbine to be optionally operated with synthesis gas from a gasification device and a second or substitute fuel, the burner in the combustion chamber assigned to the gas turbine has to be designed as a two-fuel or multi-fuel burner to which both the synthesis gas and the second fuel, for example natural gas, can be fed as required. The embodiment of a burner as a multi-fuel burner is also necessary to ensure that the gas-turbine output is available in the case of fluctuations of the calorific value in the synthesis gas. Here, the respective fuel is supplied to the combustion zone via a fuel passage in the burner.

Existing multi-fuel burners have a fuel nozzle comprising a nozzle tube connected to a first fuel supply line for gas, hereinafter referred to as natural gas, and a nozzle cover with a central point and through-openings, through which the natural gas can flow into a combustion chamber. In such cases, the through-openings are provided in the nozzle cover arranged in the circumferential direction on a circular line. A so-called web with a sufficient web width forms in the nozzle cover between the through-openings in the nozzle cover.

A fuel nozzle known from the prior art, which is primarily described for use in conjunction with a diesel internal combustion engine is taught in US 2005/0224605 A1. A comparable fuel nozzle is, for example, also known, from US 2007/0215099 A1. A fuel nozzle for use with a gas turbine is disclosed in US 2008/0083229 A1. However, none of the fuel nozzles known from the prior art deal with the problem of improved cooling of the fuel nozzle during combustion operations.

So far, it has not been necessary to cool the nozzle cover with the through-openings. If synthesis gas is now used in addition to natural gas operation, an outer sheath is arranged spaced apart radially around the nozzle tube, said outer sheath forming an annular gap with the nozzle tube. The annular gap is connected to a second fuel supply line, approximately comparable to a synthesis gas supply described in US 2008/0083229 A1, in order to feed synthesis gas to the annular gap. In such an arrangement, the nozzle cover heats up greatly, in particular in part-load operation, since here the pulse of the fuel flowing through the nozzle cover is very low. The heating causes the nozzle cover to heat up such that thermal stresses form therein and result in wear. This reduces the lifetime of the entire fuel nozzle.

The fuel nozzles known from the prior art also fail to take account of the problem of controlled fuel feed through the through-openings. For example, it is has been found that, with certain operating conditions, an unwanted flash-back through the through-openings can take place. This in particular impedes uniform fuel feed through the through-openings.

### SUMMARY OF INVENTION

It is therefore an object of the invention to disclose a fuel nozzle characterized by a high lifetime. It should also be an object of the present invention to suggest a gas turbine combustion chamber with such a fuel nozzle, or an actual fuel nozzle, which permits controlled and directed fuel feed through the through-openings of the fuel nozzle. A further object is the disclosure of a burner with such a fuel nozzle.

The objects are achieved by the disclosure of a fuel nozzle, a gas turbine combustion chamber and a burner as claimed in the claims.

The gas turbine combustion chamber has at least one fuel nozzle, wherein at least one fuel nozzle is embodied as claimed in the claims.

According to the invention, this at least one fuel nozzle comprises a nozzle cover with a central point, wherein the nozzle cover has a number of through-openings, through which the fluid that is made to flow into the nozzle tube leaves and wherein the through-openings are arranged with different radial distances from the central point on at least two circular lines. This results in better cooling of the nozzle cover, in particular around the central point, without any reduction in the stability of the combustion in a combustion chamber arranged downstream of the fuel nozzle. This enables thermal stresses to be avoided and the lifetime of the nozzle to be increased. In addition, for better cooling, more through-openings can be arranged in the nozzle cover than is the case with the nozzle from the prior art since sufficient web width is also ensured with more through-openings.

Furthermore, the fuel nozzle according to the invention is embodied such that at least one of the through-openings comprises an upstream bellmouth. The effect of the bellmouth is in particular the fact that no recirculation can take place in the through-opening in question. This enables flash-back to be avoided. It is also possible for the bellmouth to be used to guide fuel, for example, natural gas, synthesis gas or even liquid fuel through the through-opening in a directed manner.

Further features, properties and advantages of the present invention may be derived from the following description of exemplary embodiments with reference to the attached FIGS. 1 to 8.

### BRIEF DESCRIPTION OF THE DRAWINGS

FIG. 1 shows a fuel nozzle in cross section.

FIG. 2 shows a nozzle cover.

FIG. 3 is a schematic view of the fuel nozzle with the different aperture angles of the through-openings.

FIG. 4 shows a section of a nozzle cover with a through-opening and a bellmouth with a fuel injector according to a first exemplary embodiment of the invention.

FIG. 5 shows a section of a nozzle cover with a through-opening and a bellmouth with a fuel injector according to a second exemplary embodiment of the invention.

FIG. 6 shows a section of a nozzle cover with a through-opening and a bellmouth according to a further embodiment of the invention.

FIG. 7 shows a fuel nozzle in a synthesis gas burner.

FIG. 8 shows a fuel nozzle in a gas turbine combustion chamber.

### DETAILED DESCRIPTION OF INVENTION

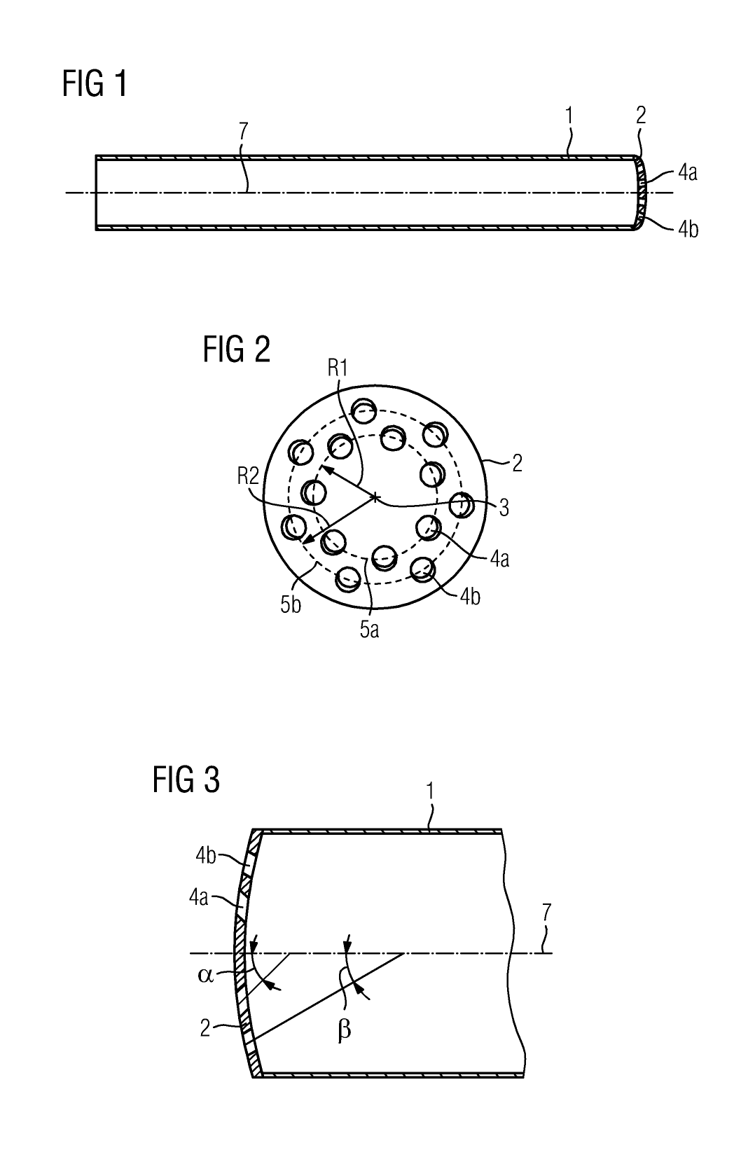

FIG. 1 shows a fuel nozzle with a cylindrical nozzle tube 1 and a convex nozzle cover 2. The fuel nozzle 1 has a cylinder axis 7. A fluid, in particular a fuel, is introduced into the fuel nozzle 1, said fuel subsequently emerging through the through-openings 4a, 4b into a downstream combustion chamber (not shown).

FIG. 2 is a front view of a nozzle cover 2. The nozzle cover 2 has a central point 3. The nozzle cover 2 also has a number of through-openings 4a, 4b. The through-openings 4a, 4b are arranged at different radial distances R1, R2 from the central point 3 on at least two circular lines 5a, 5b. In such cases, the through-openings 4a are arranged on the circular line 5a with a radius R1 from the central point 3. In such cases, the circular line 5a with the smaller radius R1 is termed the radial internal circular line 5a. Compared with nozzles from the prior art, now more fuel or, if the fuel is premixed, more fuel-air mixture is transported through the through-openings 4a, which lie on the radial internal circular line 5a, to the central point 3 of the nozzle cover 2. This prevents the overheating of the nozzle cover 2, in particular around the central point 3. This also prevents flashback. This reduces the temperature of the nozzle cover 2 compared to nozzles from the prior art. At the same time, the through-openings 4a on the circular line 5a have the same radial inflow as the through-openings 4b on the other circular line 5b.

In this way, the distance between the through-openings 4a or 4b in the nozzle cover 2 is increased compared to nozzles from the prior art. This also increases the web width between the through-openings 4a or 4b. This reduces the risk of cracking. In addition, with a constant circumference of the nozzle cover 2, the total number of through-openings 4a, 4b is higher than it is in the case nozzles from the prior art. In addition, it is possible for the diameter of the through-openings 4a or 4b to be increased without the web width between the through-openings 4a or 4b becoming too small. The higher number of through-openings 4a, 4b and optionally also the larger diameter of the through-openings 4a, 4b can enable more efficient cooling in the nozzle cover 2 due to improved distribution of the fluid flowing through the through-openings 4a, 4b. This achieves improved cooling, in particular around the central point 3 of the nozzle cover 2. In addition, a larger number of through-openings 4a, 4b and optionally in addition the larger diameter of the through-openings 4a, 4b reduces the area of nozzle cover itself; this means that the area in the nozzle cover 2 exposed to attack and adhesion and hence damage from the flame in the combustion chamber (not shown) is smaller.

A further advantage of a fuel nozzle of this kind consists in the fact that the arrangement of the through-openings on the different circular lines 5a, 5b causes the total pressure drop at the through-openings 4a, 4b to be lower than the total pressure drop at the through-openings of other fuel nozzles. This results in more stable combustion. The through-openings 4a, 4b on a circular line 5a, 5b are arranged equidistantly from each other. This results in symmetrical flow of the fuel into the downstream combustion chamber (not shown). This is necessary for uniform combustion of the fuel. The through-openings 4a on the one circular line 5a are arranged offset by an angle with respect to the through-openings 4b on the other circular line 5b. The number of through-openings 4a, 4b on the two circular lines 5a, 5b can be the same or even different (not shown). Similarly, the through-openings 4a, 4b can have different or the same diameters (not shown).

FIG. 3 is a schematic cross section through a fuel nozzle with a nozzle tube 2 with a cylinder axis 7 and nozzle cover 2. FIG. 3 also shows that the through-openings 4a, 4b on the different circular lines 5a, 5b each form a different aperture angle α, β with the cylinder axis 7. In such cases, the through-openings 4a on the radially internal circular line 5a have a larger aperture angle a than the through-openings 4b, which are arranged on the radially exterior circular line 5b. For example, the through-openings 4a can have an aperture angle α=45° and the through-openings 4b an aperture angle β=30°. This causes the through-openings 4a on the circular line 5a to have the same radial fuel flow as the through-openings 4b on the circular line 5b. This causes a stable, hot recirculation zone of the fuel or the fuel-air mixture to form in the combustion chamber (not shown). The recirculation zone is so-to-speak pushed away from the nozzle cover 2 by the fluid, which is made to flow through the additional through-openings 4a in the combustion chamber (not shown). This to a large extent prevents the nozzle cover 2 from coming into contact with the hot recirculation zone. This avoids very high temperatures in the nozzle cover 2. In such cases, the aperture angle of the through-openings 4a, 4b on the different circular lines 5a, 5b is always selected such that the through-openings 4a on the circular line 5a have the same radial flow of the fluid into the combustion chamber (not shown) as the through-openings 4b on the circular line 5b.

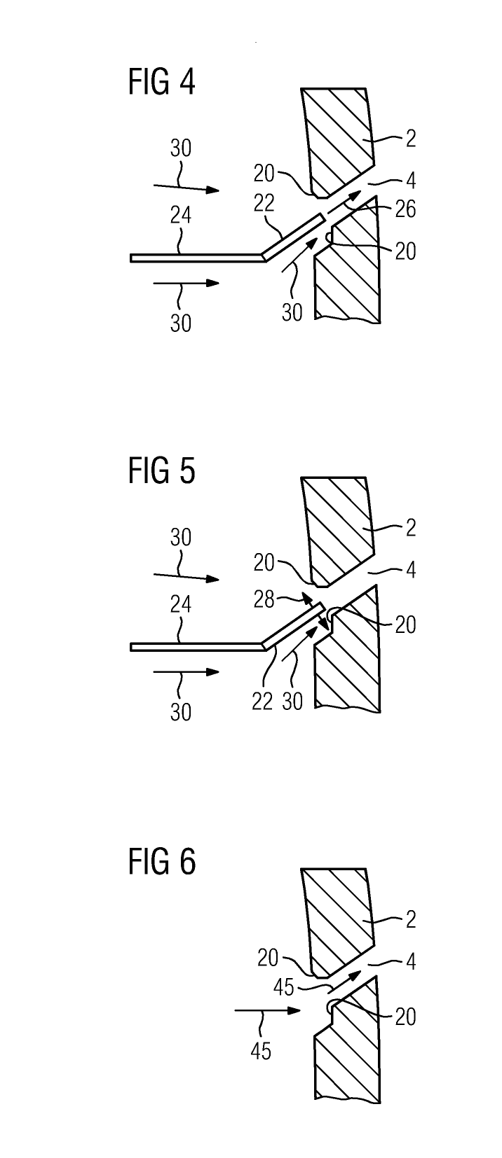

FIG. 4 shows by way of example and representative for a number of, in particular all, through-openings 4a, 4b (FIG. 2) a through-opening 4, with an upstream bellmouth 20. A fuel injector 22 can point into the bellmouth 20, said fuel injector being fed by a fuel supply line 24 arranged centrally in the nozzle tube 1 (FIG. 1). Here, the fluid conducted through the nozzle tube 1 (FIG. 1) is compressor air 30. The fuel injector 22 introduces fuel into the compressor air 30 flowing through the nozzle tube 1 (FIG. 1) at the through-openings 4. The fuel-air mixture formed in this way then enters the combustion chamber (not shown). In such cases, the fuel, which is introduced by the fuel injector 22 into the through-opening 4, can have a direction of flow 26 parallel to the compressor air 30 (FIG. 4) or a direction of flow 28 (FIG. 5) perpendicular to the compressor air 30. If there is a parallel direction of flow 26 (FIG. 4), the fuel-air mixture entering the combustion chamber (not shown) from the fuel nozzle advantageously has a greater pulse than is the case, for example, with a perpendicular flow 28 (FIG. 5) and this has a positive effect on the combustion.

FIG. 6 shows a through-opening 4 with a bellmouth 20 without a fuel injector 22 (FIGS. 4 and 5). Here, a fuel-air mixture 45 as the fluid is introduced through the through-opening 4 into the combustion chamber (not shown), i.e. fuel was mixed with air as early as in the nozzle tube 1 (FIG. 1) or even upstream of the nozzle tube 1 (FIG. 1). In such cases, a bellmouth 20, such as that shown, for example, in FIGS. 4-6 ensures that no recirculation takes place in the through-opening 4. This avoids flashback. It is also possible for fuel, for example natural gas, synthesis gas or even liquid fuel to be guided through the through-opening 4 with the bellmouth 20.

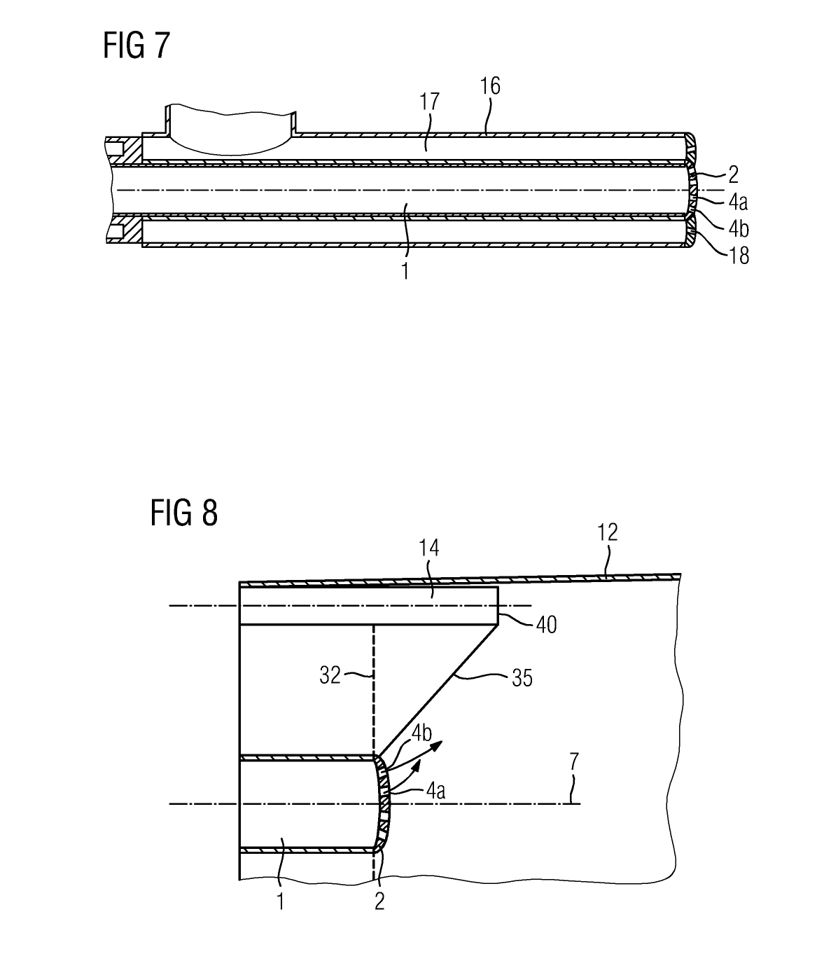

FIG. 7 shows the fuel nozzle according to the invention as a multi-fuel nozzle. In such cases, the nozzle tube 1 is connected to a first fuel supply line in order to feed a first fuel, for example natural gas with steam, into the nozzle tube 1. An outer sheath 16 is arranged spaced apart radially around the nozzle tube 1, said outer sheath forming an annular gap 17 with an annular gap outlet aperture 18 with the nozzle tube 1. In such cases, the annular gap 17 is connected to a second supply line, for example a synthesis supply line, in order to feed synthesis gas into the annular gap 17, wherein the natural gas and the synthesis gas can be made to flow through the through-openings 4a, 4b and the annular gap outlet aperture 18 into a combustion chamber (not shown). In such an arrangement, efficient cooling of the nozzle cover 2 (FIG. 1), such as that provided by the fuel nozzle according to the invention, is particularly advantageous. In addition, NOx emissions are lower in an arrangement of this kind with a fuel nozzle according to the invention. At the same time, the stability of a combustion arrangement of this kind is increased. This in turn enables the steam in the natural gas to be reduced by 10%. This reduces the overall fluid mass flow through the nozzle tube 1. As a result, there is advantageously a lower pressure drop at the nozzle cover 2.

FIG. 8 shows the fuel nozzle in a gas turbine combustion chamber. Here, the fuel nozzle, comprising a nozzle tube 1 and through-openings 4a, 4b is arranged in the central section of a tube 12 opening at one end toward a combustion chamber (not shown). A number of main burners 14 is arranged around the fuel nozzle with respect to the radial direction. In such cases, the main burners 14 comprise main outlet apertures 40 pointing into the combustion chamber (not shown). The through-openings 4a, 4b of the fuel nozzle point into the same combustion chamber (not shown). The nozzle cover 2 with the through-openings 4a, 4b is arranged upstream of the main outlet apertures 14. This stabilizes the combustion. A cone 35 or a straight wall section 32 can be used to connect the main burners 14 to the fuel nozzle.

1.-10. (canceled)

11. A gas turbine combustion chamber with a fuel nozzle, wherein the fuel nozzle comprises:
a cylindrical nozzle tube, in which a fluid flows, and
a convexly formed nozzle cover, which is arranged downstream of the nozzle tube and has a central point,
wherein the nozzle cover has a plurality of through-openings through which the fluid leaves the nozzle tube,
wherein the through-openings are arranged at different radial distances from the central point on first and second circular lines, and
wherein at least one of the through-openings comprises an upstream bellmouth.

12. The gas turbine combustion chamber as claimed in claim 11, wherein the through-openings are arranged equidistantly on the first and/or second circular lines.

13. The gas turbine combustion chamber as claimed in claim 11, wherein the nozzle tube has a cylinder axis and wherein the through-openings each form a different aperture angle with the cylinder axis on the first and second circular lines.

14. The gas turbine combustion chamber as claimed in claim 13, wherein the through-openings with a smaller radial distance have a larger aperture angle than the through-openings with a greater radial distance.

15. The gas turbine combustion chamber as claimed in claim 11, wherein the through-openings of the first circular line are arranged offset by an angle with respect to the through-openings which lie on the second circular line.

16. The gas turbine combustion chamber as claimed in claim 11, wherein a fuel injector points into at least one bellmouth, said fuel injector being fed by a fuel supply line arranged in the nozzle tube.

17. The gas turbine combustion chamber as claimed in claim 16, wherein the fuel injector injects fuel parallel and/or perpendicular to a direction of flow of the fluid flowing through the through-openings.

18. The gas turbine combustion chamber as claimed in claim 11,
wherein the fuel nozzle is arranged in a central section of a tube that opens at one end toward a combustion chamber and main burners which are arranged around the fuel nozzle in a radial direction,
wherein the main burners comprise main outlet apertures pointing into the combustion chamber,
wherein the through-openings of the fuel nozzle point into the combustion chamber, and
wherein the nozzle cover with the through-openings is arranged upstream of the main outlet apertures.

19. A burner, comprising:
a fuel nozzle with a nozzle tube and through-openings,
wherein the nozzle tube is connected to a first fuel supply line in order to feed a first fuel into the nozzle tube,
wherein an outer sheath is arranged spaced apart radially around the nozzle tube, said outer sheath forming an annular gap with an annular gap outlet aperture with the nozzle tube,
wherein the annular gap is connected to a second fuel supply line in order to feed a second fuel into the annular gap,
wherein the first fuel and the second fuel flow through the through-openings and the annular gap outlet aperture into a combustion chamber.

20. The burner as claimed in claim 19, wherein the burner is a component of a gas turbine combustion chamber as claimed in claim 11.

21. A fuel nozzle with a nozzle tube and a nozzle cover, wherein the fuel nozzle is a component of a gas turbine combustion chamber as claimed in claim 11 or of a burner as claimed in claim 19.
